(19) United States
(12) Patent Application Publication
(10) Pub. No.: US 2026/0277874 A1
(43) Pub. Date: Sep. 17, 2026

(54) COMPUTER-IMPLEMENTED METHOD AND SYSTEM FOR GENERATING A TRUTH-INTEGRITY SCORE

(71) Applicant: The Mirror Project LLC, Boca Raton, FL (US)

(72) Inventor: Scott Lipskin, Boca Raton, FL (US)

(73) Assignee: The Mirror Project LLC, Boca Raton, FL (US)

(21) Appl. No.: 19/675,097

(22) Filed: May 12, 2026

Related U.S. Application Data
(63) Continuation of application No. 19/436,069, filed on Dec. 30, 2025.
(60) Provisional application No. 63/926,018, filed on Nov. 26, 2025.
(60) Provisional application No. 63/922,189, filed on Nov. 21, 2025.

(51) Int. Cl. G06F 16/23; G06F 16/21; G06F 16/215; G06F 16/25

(52) U.S. Cl. CPC G06F 16/2365; G06F 16/215; G06F 16/219; G06F 16/258

(57) ABSTRACT

A computer-implemented method is provided for generating a truth-integrity score. The method includes receiving a target item at an input ingest and normalization layer. The target item may include first data corresponding to at least one of a textual claim, a document excerpt, an image, a video, a profile, and a URL. The method may also include converting the first data into second data corresponding to an evidence graph, and applying independence-aware consensus and dynamic weighting to the second data with a scoring engine in order to generate the truth-integrity score.

### CROSS-REFERENCE TO RELATED APPLICATIONS

This application is a continuation patent application which claims priority to and claims the benefit of U.S. Patent Application Serial No. 19/436,069, filed December 30, 2025, which claims priority to and claims the benefit of U.S. Provisional Patent Application Serial No. 63/922,189, filed November 21, 2025, as well as U.S. Provisional Patent Application Serial No. 63/926,018, filed November 26, 2025, the contents of which are each incorporated herein by reference in their entirety.

### BACKGROUND OF THE INVENTION

It is common for various types of content to be shared over the internet and through other mediums. Society functions best when more truthful information is considered in conversation and elsewhere. It is thus desirable to know the truth about content being circulated through various mediums, including the internet.

It is with respect to these and other considerations that the instant disclosure is concerned.

### SUMMARY

In one aspect of the disclosed concept, a computer-implemented method is provided for generating a truth-integrity score. The method comprises receiving a target item at an input ingest and normalization layer, the target item comprising first data corresponding to at least one of a textual claim, a document excerpt, an image, a video, a profile, and a URL; converting the first data into second data corresponding to an evidence graph; and applying independence-aware consensus and dynamic weighting to the second data with a scoring engine in order to generate the truth-integrity score.

In another aspect of the disclosed concept, a system is provided for generating a truth-integrity score. The system comprises an input ingest and normalization layer configured to receive a target item, the target item comprising first data corresponding to at least one of a textual claim, a document excerpt, an image, a video, a profile, and a URL; an entity extraction module configured to convert the first data into second data corresponding to an evidence graph; and a scoring engine configured to apply independence-aware consensus and dynamic weighting to the second data in order to generate the truth-integrity score.

### BRIEF DESCRIPTION OF DRAWINGS

FIG. 1 shows a computer-implemented method for generating a truth-integrity score, in accordance with one non-limiting embodiment of the disclosed concept.

FIG. 2A shows a simplified view of a portion of a system which may execute the method of FIG. 1, shown with a target item and a truth-integrity score in dashed line drawing, in accordance with one non-limiting embodiment of the disclosed concept.

FIG. 2B shows a schematic of the system of FIG. 2A, showing additional system components and also not showing certain components which are shown in FIG. 2A, in accordance with one non-limiting embodiment of the disclosed concept.

FIG. 3 shows a structural representation of a portion of the truth-integrity score generated by the system of FIGS. 2A and 2B.

### DETAILED DESCRIPTION OF THE INVENTION

In the following description, for the purposes of explanation, numerous specific details are set forth in order to provide a thorough understanding of various embodiments of the invention. As used herein, “embodiments” are non-limiting examples of apparatuses or methods employing one or more of the inventive concepts disclosed herein. It is apparent, however, that various embodiments may be practiced without these specific details or with one or more equivalent arrangements. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features of the various embodiments may be otherwise combined, separated, interchanged, and/or rearranged without departing from the inventive concepts.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “may include,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, may be used as terms of approximation and not as terms of degree, and, as such, are utilized to account for inherent deviations in measured, calculated, and/or provided values that would be recognized by one of ordinary skill in the art.

As employed herein, the term “number” shall mean one or an integer greater than one (i.e., a plurality).

As employed herein, the term “coupled” shall mean directly connected or connected via one or more parts, components, or systems.

As will be discussed below, the disclosed method and system may advantageously provide for the generation of a truth-integrity score that has a transparent, queryable rationale trail. The rationale trail may cite a number of key evidence nodes and a number of relationships between the key evidence nodes. As a result, the truth-integrity score may advantageously allow for the truthfulness of a target item to be better known, which in turn may allow ensuing conversation and discourse which contemplate that target item to be better informed.

In one example, the disclosed method and system may allow for this capability by providing for a multi-stage feature vector normalization which uses atomic propositions instead of raw claims. More specifically, the disclosed method and system may organize and evaluate information through a structured truth-integrity process by combining multiple types of existing technologies—such as signal analysis, behavioral mapping, and contextual verification—into a desirable framework that ranks authenticity and filters misinformation in real time. Thus, the disclosed multi-stage, verification-driven information analysis system may be designed to determine the integrity, factual accuracy, and multi-source alignment of claims contained within online content by ingesting a target item from a user, decomposing the target item into structured components, retrieving and normalizing supporting/dissenting evidence, and producing an aggregated evidence vector representing the state of factual alignment across reputable sources.

The disclosed method and system may also allow for real-time fact ingestion rather than static knowledge, such as to provide for automated evidence ingestion and priority weighting to peer-reviewed multi-sourced data. Additionally, the disclosed method and system may comprise anti-hallucination enforcement rules in order to ensure only verifiable outputs, such as to call for minimal or no generative inference, uncertainty being flagged instead of filled, and confidence-band scoring. Moreover, the disclosed method and system may also provide for domain-modular scale architecture (e.g., without limitation, medical, political, scientific, etc.), such as via vertical-by-vertical rollout architecture, domains that are each self-contained for licensing and scaling, and integrity aggregation across domains. Furthermore, the disclosed method and system may include dispute/appeal revision protocols to revise scoring when new evidence surfaces, such as via at least one of evidence submission channels, claim review and automatic re-scoring, and integrity redistribution after correction.

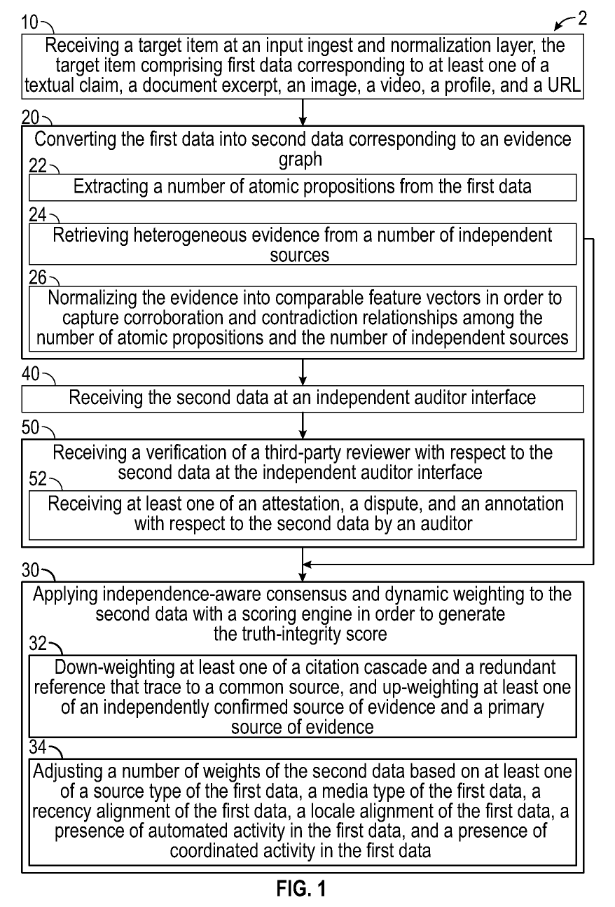

FIG. 1 shows an example computer-implemented method 2 for generating the aforementioned truth-integrity score. In one example, the method 2 includes a first step 10 of receiving a target item at an input ingest and normalization layer, the target item comprising first data corresponding to at least one of a textual claim, a document excerpt, an image, a video, a profile, and a URL; a second step 20 of converting the first data into second data corresponding to an evidence graph; and a third step 30 of applying independence-aware consensus and dynamic weighting to the second data with a scoring engine in order to generate the truth-integrity score.

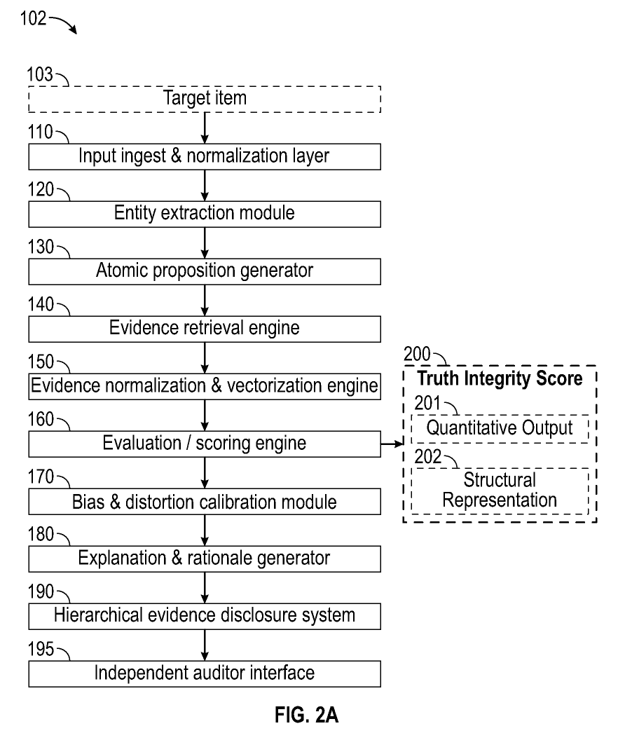

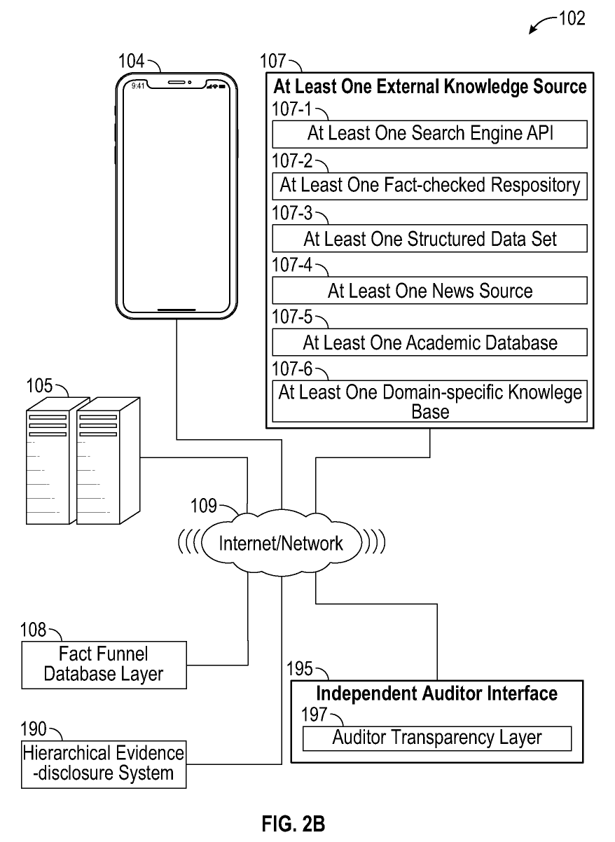

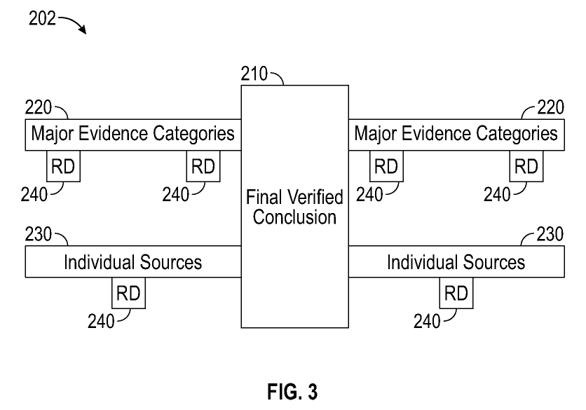

FIGS. 2A and 2B show different views of a system 102 for generating a truth-integrity score 200, and for executing the method 2 of FIG. 1. The truth-integrity score 200 may include a quantitative output 201, which may comprise a numerical truth score, and may also include a structural representation 202, which may not be a separate scoring mechanism. In accordance with the disclosed concept, the structural representation 202 may be in the form of an integrity tree. This is shown in FIG. 3, and is illustrated to depict how the quantitative output 201 was formed.

The system 102 may be understood, in one example, as being a truth-integrity engine, and not a content engine, recommendation system, or opinion framework, such that the mechanisms of the system 102 may be considered to be structural, evidentiary, and non-generative by design.

As shown in FIG. 2A, the system 102 may include an input ingest & normalization layer 110, an entity extraction module 120, an atomic proposition generator 130, an evidence retrieval engine 140, an evidence normalization & vectorization engine 150, an evaluation and scoring engine 160, a bias & distortion calibration module 170, an explanation & rationale generator 180, a hierarchical evidence disclosure system 190, and an independent auditor interface 195. Referring to FIG. 2B, the system 102 may further include a client user device 104 (e.g., without limitation, a smartphone, a tablet, a laptop, a desktop computer), at least one backend system 105 hosted on cloud servers, at least one external knowledge source 107, and at least one fact funnel database layer 108 each of which may be communicable with one another over an internet/network 109.

Regarding the functionality of the various components of the system 102, the input ingest & normalization layer 110 may be configured to receive a target item 103 (e.g., without limitation, first data corresponding to at least one of a textual claim, a document excerpt, an image, a video, a profile, and a URL), perform preprocessing, sanitization, and prepare content for structured

analysis. The entity extraction module 120 may be configured to identify entities, relationships, temporal markers, and contextual elements from the input in order to create a structured representation suitable for downstream processing (e.g., without limitation, the entity extraction module 120 may be configured to convert the first data into second data corresponding to the evidence graph). The atomic proposition generator 130 may decompose content into discrete, fact-checkable atomic propositions by stripping rhetoric from the content such that the output comprises minimal truth-eligible data units. Those data units may then be output as the atomic propositions to the evidence retrieval engine 140, which may retrieve heterogeneous evidence from independent sources (e.g., public records, databases, archives, web sources, provenance signals) relevant to each atomic proposition. The evidence normalization & vectorization engine 150 may transform retrieved evidence into comparable feature vectors, including attributes such as source independence, reliability, recency, alignment, contradiction, and manipulation risk. The evaluation and scoring engine 160 may apply independence-aware weighting and consensus logic to evaluate the evidence vectors, and generate per-proposition and aggregate truth-integrity scores. It will be appreciated that the evaluation and scoring engine 160 may thus apply dynamic weighting to the second data in order to generate the truth-integrity score 200. The bias & distortion calibration module 170 may adjust scoring to account for amplification effects, monetization bias, coordinated behavior, or algorithmic distortion originating from external platforms. The explanation & rationale generator 180 may produce structured, human-readable reasoning paths that link scores to underlying evidence relationships, as well as evidence linkages, and justification text. The hierarchical evidence disclosure system 190 may organize conclusions into a progressive disclosure structure (trunk → branches → leaves), thereby enabling traceability from final output

down to raw source data. The independent auditor interface 195 may provide a separate verification layer in order to allow third parties to access evidence vectors, scoring logic, and rationale paths; and may support attestations, disputes, annotations, and immutable audit logging without altering system outputs. That is, auditors may be able to verify conclusions of the system 102 with the independent auditor interface 195, and may do so without modifying those conclusions.

Continuing to refer to FIGS. 2A and 2B, the target item 103 may be provided via a user query, and may be sent to the backend system 105. At the backend system 105, the user query may be preprocessed, sanitized, and subjected to claim isolation. Additionally, the client user device 104 may be configured to run a browser or mobile app, and send an initial query to the disclosed system 102. The backend system 105 may provide an API gateway and entry point for a processing server cluster, the entity extraction module 120, the atomic proposition generator 130, the evidence retrieval engine 140, the evidence normalization & vectorization engine 150, the evaluation and scoring engine 160, and the independent auditor interface 190. In one example, the internet/network 109 may provide, for example, a TCP/IP connection between the client user device 104 and the backend system 105, wherein all communication may be encrypted via HTTPS/TLS. In this manner, the client user device 104 and the backend system 105 may be communicatively coupled to each other.

Moreover, in one example the system 102 may further include at least one external knowledge source 107 communicatively coupled to the client user device 104 and the backend system 105. The external knowledge source 107 may include, for example and without limitation, any combination of at least one search engine API 107-1, at least one fact-checked repository 107-2, at least one structured data set 107-3, at least one news source 107-4, at least one academic database 107-5, and at least one domain-specific knowledge base 107-6.

Referring to FIG. 2B, the fact funnel database layer 108 may be communicatively coupled to the client user device 104, the backend system 105, and the external knowledge source 107; and in one example may store extracted propositions, search metadata, evidence vectors, system logs, and version data. It will be appreciated that the database layer 108 may not store user identity. That is, the database layer 108 may be de-coupled with respect to other components of the system 102.

In terms of data flow within the system 102, in one example embodiment an input in the form of a URL, a text snippet, an article, a social media post may be ingested into the system 102, and the client may send a request corresponding to the input to an API gateway. Next, the backend system 105 may retrieve any amount of corresponding text from the external knowledge source 107 (if URL), clean HTML, remove boilerplate, and extract core editorial content. The backend system 105 may also identify persons, organizations, dates, locations, quantities, and relationships. Subsequently, the backend system 105 may decompose each sentence into one or more machine-readable propositions. For example, the statement “The mayor approved the bill in May” may become “(MAYOR, APPROVED, BILL)” and/or “(EVENT, OCCURRED, MAY 2024)”. Next, for each proposition, the external knowledge source 107 may perform multi-source search queries, structured corpus lookups, cross-reference against known fact-checking databases, and reverse-claim matching.

Next, the system 102 may perform evidence normalization, including converting all signals into a unified, comparable evidence vector that includes at least one of an alignment score, a contradiction score, an uncertainty score, a source distribution, and a weighted credibility value. In one example, the evidence normalization & vectorization engine 150 may provide for reliable scoring, independent weighting, recency evaluation, contradiction detection, and manipulation risk. Additionally, the system 102 may perform evidence vector aggregation by aggregating vectors for substantially all or all propositions in order to produce at least one of an overall claim integrity score, a multi-source agreement map, and a categorized support/contradiction breakdown. In terms of output, results may then be displayed to the user via being sent to and displayed through the client user device 104, and in one example embodiment, a full evidence set may be logged and available to the independent auditor interface 190.

It will be appreciated that the system 102 may receive an input of the target item 103, and the entity extraction module 120 may then identify and extract content, and output a structured list of entities, relationships, temporal markers, and contextual metadata. The content that is identified and extracted may be, for example and without limitation, named entities (e.g., persons, organizations, events, dates, and locations), relationships among entities, and contextual markers (e.g., time windows, scope, and conditions). In one example, the purpose of these steps may be to form an architecture, such as scaffolding, for downstream atomic proposition extraction.

Continuing to refer to FIGS. 2A and 2B, the system 102 may also receive an input of a structured entity set, convert content from the input into discrete, fact-checkable, standalone claims, and output a list of normalized atomic claims. In one example, converting content may include stripping each atomic proposition of rhetoric, emotive framing, and non-factual language, and reducing each proposition to a minimal truth data unit (e.g., without limitation, “X occurred on Y date,” “Person A said statement B,” “Agency C published report D”). The purpose of providing the atomic proposition extraction may be to create uniform statements that can be evaluated consistently across sources.

It will also be appreciated that the evidence retrieval engine 140 may retrieve evidence from at least one of a trusted source corpus, at least one verified historical record, at least one public document, and at least one credibility-qualified database. The evidence normalization & vectorization engine 150 may then convert extracted evidence into feature vectors representing at least one of source reliability, claim alignment, chronological relevance, contradiction score, corroboration density, and semantic distance between claim and evidence. Evidence may then be reduced by the system 102 to a mathematically comparable format in order to allow for consistent scoring, and outputted as a normalized evidence matrix. The evidence normalization & vectorization engine 150 may thus evaluate truth using a standardized scoring framework which is not dependent on any specific source’s language, style, or rhetoric. Subsequently, the evaluation and scoring engine 160 may receive an atomic proposition, retrieve relevant evidence sources, convert evidence to feature vectors, compare against a proposition vector, provide a score alignment, contradiction, and uncertainty, and then aggregate a truth score and generate a structured explanation path.

In accordance with the disclosed concept and with reference again to FIG. 1, the method 2 may optionally include a step 40 of receiving the second data at the independent auditor interface 195, and a step 50 of receiving a verification of a third-party reviewer with respect to the second data at the independent auditor interface 195. The step 40 may optionally include a first step of receiving at least one of a number of raw evidence vectors, a number of source credibility weights, and a primary system’s final score; a second step of performing a second truth evaluation, a cross-verification, a bias detection, and a probability recalibration; and/or a third step of returning at least one of an indication (e.g., without limitation, “Confirmed”, “Adjusted”, “Flagged for manual review”), an explanation of discrepancies, and a confidence delta between systems. The steps 40,50 may thus represent a structural safeguard that improve system trustworthiness by providing a second, independently operating model that evaluates the output of the system 102, as opposed to evaluating a claim of the user. Accordingly, the independent auditor interface 195 may allow third-party reviewers (e.g., without limitation, auditors, human experts and/or institutional partners) to verify the evidence graph and rationale trail through a controlled, tamper-evident dashboard or application programming interface (API), such as by exposing an entire evidence set, normalized vectors, and supporting source metadata in a transparent review environment. As a result, an advantageous layer of auditability is provided to the system 102 by the independent auditor interface 195.

Furthermore, the step 50 may include a step 52 of receiving at least one of an attestation, a dispute, and an annotation with respect to the second data by an auditor. Third-party reviewers may thus attest to, dispute, or annotate system outputs without altering the underlying record, and each review may be immutably recorded to maintain transparency. As such, the method 2 may further include immutably recording the verification in order to maintain transparency of the verification, and the step 50 may be performed without altering the second data.

Referring to FIG. 2B, the independent auditor interface 195 may include an auditor transparency layer 197 in order to provide the system 102 with any and all lists of extracted propositions, any and all supporting and contradicting evidence, source-credibility weights, time stamps, query parameters used, normalized evidence vectors, algorithmic ranking steps, any and all retrieved links in raw form, and human-readable trails for every decision. In this manner, an external auditor, such as an individual unaffiliated with operators of the system 102, may replicate conclusions of the system 102, verify retrieval paths, confirm source neutrality, audit scoring consistency, and cross-check vector calculations. It will also be appreciated that the independent auditor interface 195 may include an auditor console, an evidence list, a vector breakdown, source metadata, and audit logs.

Referring again to FIGS. 2A and 2B, the scoring engine 160 may apply independence-aware consensus and dynamic weighting to the abovementioned evidence graph. This weighting may include down-weighting citation cascades and redundant references that trace to a common origin, while up-weighting independently confirmed or primary-source evidence. The scoring engine 160 may also adjust weights based on source type (e.g., without limitation, primary vs. derivative), media type (e.g., without limitation, text, image, video), recency/locale alignment, and the presence of automated or coordinated activity. For media items, the system 102 may integrate artificial intelligence (AI)-generation and manipulation detectors, metadata/EXIF validation, and cross-platform voice/face/handle linkage as additional nodes in the abovementioned graph. The output may thus be the bounded truth-integrity score 200 accompanied by a rationale trail citing the key evidence nodes and their relationships, which may all be written to a cryptographically signed audit log.

Accordingly, the step 30 of FIG. 1 may further include a step 32 of down-weighting at least one of a citation cascade and a redundant reference that trace to a common source and up-weighting at least one of an independently confirmed source of evidence and a primary source of evidence. The step 30 may also and/or may alternatively include a step 34 of adjusting a number of weights of the second data based on at least one of a source type of the first data, a media type of the first data, a recency alignment of the first data, a locale alignment of the first data, a presence of automated activity in the first data, and a presence of coordinated activity in the first data. In an example wherein the step 30 includes adjusting a number of weights of the second data based on the media type of the first data, the method 2 may further include integrating a number of artificial intelligence (AI) generation and manipulation detectors, metadata and exchangeable image file format validation, and cross-platform voice, face, and handle linkages as a number of additional nodes in the evidence graph.

Continuing to refer to FIG. 1, the step 20 may further include a step 22 of extracting a number of atomic propositions from the first data, a step 24 of retrieving heterogeneous evidence from a number of independent sources, and a step 26 of normalizing the evidence into comparable feature vectors in order to capture corroboration and contradiction relationships among the number of atomic propositions and the number of independent sources. In simple terms, the system 102 may funnel facts by ingesting the target item 103 (e.g., without limitation, a textual claim, document excerpt, image, video, profile, and/or URL), and in response constructing an evidence graph by (i) extracting entities and/or atomic propositions, (ii) retrieving heterogeneous evidence from independent sources (e.g., without limitation, a number of news archives, a number of government and/or public records, a number of academic databases, at least one web content, a number of social graphs, and a number of media provenance signals), and (iii) normalizing substantially all or all evidence into comparable feature vectors. It will also be appreciated that the comparable feature vectors may be based on recency, authorship, independence, historical reliability, geotemporal fit, and manipulation risk, and the evidence graph may capture corroboration and contradiction relationships among propositions and sources.

Accordingly, it will be appreciated that the disclosed concept provides for a multi-stage, verification-driven information analysis system 102 designed to determine the integrity, factual accuracy, and multi-source alignment of claims contained within online content. The system 102 may do this by ingesting a user-submitted input (e.g., without limitation, a URL, text excerpt, full web page, etc.), decomposing the input into structured components, retrieving and normalizing supporting/dissenting evidence, and producing an aggregated evidence vector representing the state of factual alignment across reputable sources.

Regarding bias, in one example the method 2 may further include performing bias calibration on the second data with the bias & distortion calibration module 170 in order to account for distortion effects introduced by at least one of monetization and engagement-driven ranking algorithms used by third-party platforms. In some embodiments, performing bias calibration in this manner may account for distortion effects introduced by monetization or engagement-driven ranking algorithms used by third-party platforms. The bias & distortion calibration module 170 may thus analyze historical engagement and promotion patterns to detect non-content-based amplification signals (e.g., without limitation, click-through incentives, ad-driven visibility boosts, coordinated virality). The system 102 may then apply counterweight adjustments to normalize these external distortions before computing the final truth-integrity score 200, thereby ensuring that scoring remains grounded in evidentiary integrity rather than monetization bias or algorithmic popularity.

In certain embodiments, the disclosed method 2 and system 102 may funnel facts by including a recommendation engine that first analyzes low-confidence or contradictory outputs and second proposes targeted corrections or next-step actions. When the system 102 detects instability in the truth-integrity score 200, such as conflicting evidence clusters or missing independent confirmations, the method 2 and system 102 may automatically identify the weakest nodes in the graph and suggest new queries, data sources, or alternative phrasing to improve reliability. As a result, users or auditors may iteratively refine an information claim toward a higher truth-integrity, thereby establishing a feedback loop between scoring, explanation, calibration, and correction. In this manner, the method 2 may further include detecting an instability in the truth-integrity score 200, automatically identifying a weakest node in the evidence graph, and suggesting at least one of a new query, a new data source, and an alternative phrasing in order to improve a reliability of the truth-integrity score 200 and allow for an iterative refinement of the second data toward a higher truth-integrity.

As shown in FIG. 2A, the system 102 may include the hierarchical evidence-disclosure system 190, which is communicatively coupled to each of the client user device 104, the backend system 105, the external knowledge source 107, the fact funnel database layer 108, and the independent auditor interface 195 via the internet/network 109. In one example, the hierarchical evidence-disclosure system 190 may function as a transparency layer of the system 102 by first starting with a final verified conclusion (e.g., a trunk), and second allowing users to progressively expand into major evidence categories, individual sources, as well as raw-data elements (e.g., major evidence categories may function as primary branches, individual sources may function as secondary branches, and raw data may function as leaves). The structure of the hierarchical evidence-disclosure system 190 advantageously allows the verification process and reasoning chain to be fully traceable from a top-level answer all the way down to an originating piece of data via stepwise expansion, and all while preserving the underlying multi-source, cross-validated logic discussed hereinabove.

In one example, the method 2 may include receiving a user-submitted claim, decomposing the claim into component parts, performing independent verification of each component across multiple categories, generating convergence and divergence scores (e.g., each node may contain metadata comprising an independence score, divergence data, and explanations), constructing hierarchical evidence nodes with the hierarchical evidence-disclosure system 190, rendering nodes in a progressive-disclosure interface (e.g., without limitation, expand and collapse the nodes to allow the user to interact with structure of the system 102), allowing users to trace conclusions to raw-source data, and providing a transparent reasoning chain for each node such that users may trace conclusions to root-level sources. It will be appreciated that the method 2 may also include steps of progressively expanding at least one evidence node, displaying a raw-source data at terminal nodes, employing multi-source independent verification and divergence mapping, and generating a transparent reasoning chain for user interpretation.

Referring to FIG. 3, the structural representation 202 may represent evidentiary relationships, dependencies, and confidence propagation, and the quantitative output 201 (FIG. 2A) may be computed from the structural representation 202. As shown, the structural representation 202 may include a final verified conclusion functioning as a trunk 210, at least one major evidence category digitally extending from the final verified conclusion and functioning as a primary branch 220, and at least one individual source digitally extending from the final verified conclusion 210 and functioning as a secondary branch 230. The structural representation 202 may also include raw data “RD” digitally extending from each of the major evidence categories and the individual sources and functioning as leaves. In one example, the structural representation 202 advantageously functions to provide a transparent representation of where a final verified conclusion is derived from in the system 102, all the way down to the raw data which contributed to its determination. In terms of improving discourse, users viewing the structural representation 202 may advantageously know more fully where information has come from and how truthful it is, thereby allowing for more honest conversation both over the internet and in person.

At the trunk 210, the final verified conclusion may be provided based on a convergence of all of the evidence. At the primary branches 220, high-level justification categories may be provided based on replicated studies, historical data, and cross-regional comparisons. At the secondary branches 230, individual evidence sources may be validated independently. At the leaves 240, raw data, statistical tables, citations, sample sizes, method, and limitations may be provided.

Additionally, the system 102 may further have a number of machine-enforced policies in order to dynamically display the structural representation 202 to a user, wherein such policies may be part of instructions of a memory or other storage of the system 102. It will be appreciated that such machine-enforced policies may operate on data structures representing the evidence graph and associated metadata, rather than being abstract or purely conceptual. That is, such machine-enforced policies may be rules or mechanisms that operate on underlying data structures, such as threshold-based pruning of low-confidence nodes, confidence decay over time, redundancy or correlation suppression, conflict-resolution logic, normalization or reweighting routines, update-triggered recalculation, and/or limits on branch depth and/or density. In one example, such policies may act directly on stored evidence data in order to prevent inflation, drift, or structural distortion of the structural representation 202.

Accordingly, in one example the method 2 may further include applying a first machine-enforced policy to the second data in order to govern a formation, a depth, and a weight of both the primary branch 220 and the secondary branch 230; and/or applying a second machine-enforced policy to the second data in order to prevent a density of each of the primary branch 220 and the secondary branch 230 from being artificially inflated; and/or applying a third machine-enforced policy to the second data in order to automatically prune the structural representation 202 responsive to at least one of a corresponding weakness determination and a corresponding redundancy determination.

In one example, it will be appreciated that the disclosed method 2 and system 102 may provide for source independence and collapse detection, for example because truth may not be discernable through artificial consensus. Accordingly, the method 2 may include detecting citation dependency and source lineage within the second data; identifying at least one evidence chain within the second data that originates from a single primary source; and/or automatically de-weighting a first portion of the second data that collapses into a single origin; and/or identifying a second portion of the second data as being independently corroborated; and/or preventing echo amplification among a third portion of the second data, the third portion comprising a plurality of sources each repeating an identical unverified claim.

In one example, it will be appreciated that the disclosed method 2 and system 102 may provide for a separation of integrity and confidence surfaces, for example because truth strength and system certainty are not intended to be conflated. Accordingly, the method 2 may further include basing the truth-integrity score 200 on a quality of the second data, an independence of the second data, and a verification of the second data; and/or generating a confidence score representing a certainty level with respect to an evaluation of the truth-integrity score 200; and/or prohibiting the truth-integrity score 200 and the confidence score from collapsing into a single scalar output; and/or sending an output comprising the truth-integrity score 200 and the confidence score to a user device such that the output ranges from a low integrity level and a high confidence level to a high integrity level and a low confidence level.

In one example, it will be appreciated that the disclosed method 2 and system 102 may provide for evidence staleness, decay and temporal integrity modeling, in one example because truth validity change over time. Accordingly, the method 2 may further include applying a time-based decay function to a number of evidence inputs associated with the second data; and/or automatically reducing an integrity weight for a first evidence input of the number of evidence inputs because the first evidence input is at least one of aged and outdated; and/or providing a temporal integrity warning to a user device if a portion of the second data of the truth-integrity score 200 is determined to be stale data; and/or automatically triggering a review required state responsive to a predetermined time threshold having been exceeded in the generation of the truth-integrity score 200; and/or storing the truth-integrity score 200 in a storage for comparison to other truth-integrity scores.

In one example, it will be appreciated that the disclosed method 2 and system 102 may provide for an explainability threshold and minimum trace enforcement, at least because outputs (e.g., without limitation, the truth-integrity score 200) must meet a minimum evidentiary standard. Accordingly, the method 2 may further include establishing a minimum traceability requirement for the second data before outputting the truth-integrity score 200 as an output to a user device; and/or automatically suppressing the output if at least one evidence path of the second data falls below a predetermined explainability threshold; and/or determining whether the second data comprises a sufficient level of evidence, a determinable level of evidence, a complete level of evidence, and a conflict-free level of evidence; and/or preventing the truth-integrity score 200 from being generated if the second data does not comprises at least one of the sufficient level, the determinable level, the complete level, and the conflict-free level.

In one example, it will be appreciated that the disclosed method 2 and system 102 may provide for evidence lineage and provenance tracking, in one example because every integrity outcome must be auditable. Accordingly, the method 2 may include determining a number of original evidence sources associated with the second data; and/or providing for full provenance tracking from the number of original evidence sources to an output comprising the truth-integrity score 200; and/or storing a number of evidence transformation steps associated with at least one of converting the first data into the second data, and applying independence-aware consensus and dynamic weighting to the second data, the number of evidence transformation steps comprising at least one of a filtering step, a weighting step, and an aggregation step; and/or logging an evidence lineage associated with the second data in order to verify and review how the truth-integrity score 200 was generated.

In one example, it will be appreciated that the disclosed method 2 and system 102 may provide for cross-domain containment and integrity isolation, in one example because truth domains must remain structurally isolated. Accordingly, the method 2 may further include separating the second data into a plurality of isolated domains each corresponding to at least one of a logical category of claim type and a subject matter type (e.g., without limitation, wherein verification contexts apply different evaluation rules depending on subject matter – for example medical, legal, financial, historical, scientific, etc., and wherein each domain may represent a scoped policy environment with its own thresholds, weighting, logic, and validation rules); preventing integrity leakage across a number of domains of the plurality of domains which have been determined to be unrelated to one another; providing at least one independent scoring model for each of the plurality of domains; performing validation of at least one of the plurality of domains; and performing cross-domain aggregation on the at least one of plurality of domains after validation has been performed. In one example, such domains may not be user interface domains, but may be classifications internal to the system 102 which are used to apply differentiated enforcement or calibration logic.

In one example, it will be appreciated that the disclosed method 2 and system 102 may provide for integrity drift detection and correction because behavior of the system 102 must remain stable over time. Accordingly, the method 2 may further include detecting drift of the truth-integrity score 200 due to at least one of model updates, data shifts, and ingestion changes; and/or automatically sending an alert to a user device if the truth-integrity score 200 has deviated beyond a defined threshold; and/or restoring alignment of the truth-integrity score 200 with a prior integrity baseline responsive to at least on re-evaluation protocol being applied to the truth-integrity score 200; and/or storing a pre-drift state and a post-drift state of the truth-integrity score 200.

In one example, it will be appreciated that the disclosed method 2 and system 102 may provide for a source reliability calibration layer, namely because not all sources are configured to be equal to each other. Accordingly, the method 2 may further include continually calibrating a source reliability associated with the second data based on historical accuracy; and/or dynamically adjusting a source weighting associated with the second data over time; and/or separating a source popularity associated with the second data from the source reliability; and/or generating a plurality of other truth-integrity scores; and/or penalizing a number of sources associated with the second data based on the number of sources repeatedly degrading integrity outcomes in the truth-integrity score 200 and the plurality of other truth-integrity scores.

In one example, it will be appreciated that the disclosed method 2 and system 102 may provide for refusal-first output governance, particularly because silence may be a desirable answer. Accordingly, the method 2 may further include preventing the truth-integrity score 200 from being outputted as an output to a user device responsive to a predetermined integrity threshold not being met by the truth-integrity score 200; and/or prohibiting at least one of speculation and inferential completion from being associated with the generation of the truth-integrity score 200; and/or limiting the output to evidence-supported conclusions only; and/or distinguishing within the output between unknown portions, unsupported portions, and false portions.

In one example, it will be appreciated that the disclosed method 2 and system 102 may provide for claim state lifecycle management, namely because claims evolve. Accordingly, the method 2 may further include distinguishing within the second data between claim states corresponding to an unverified state, a supported state, a weakened state, a contradicted state, and a retired state; and/or automatically transitioning between the claim states based on an evidence change; and/or preventing the evidence change from being undetected (e.g., without limitation, prevention of silent claim mutation); and/or storing the claim states of the second data in a storage in order to allow for audit and comparison of the claim states. Accordingly, the system 102 may prevent untracked or implicit modification of previously evaluated claims, which may include versioning, provenance tracking, audit logs, and state comparison so that changes to evidence or conclusions are explicit, attributable, and reviewable rather than silently altered as new data arrives.

It will be understood that the abovementioned arrangements of apparatus are merely illustrative of applications of the principles of this invention and many other embodiments and modifications may be made without departing from the spirit and scope of the invention as defined in the claims.

What is claimed is:

1. A computer-implemented method for generating a truth-integrity score, comprising:
receiving a target item at an input ingest and normalization layer, the target item comprising first data corresponding to at least one of a textual claim, a document excerpt, an image, a video, a profile, and a URL;
converting the first data into second data corresponding to an evidence graph; and
applying independence-aware consensus and dynamic weighting to the second data with a scoring engine in order to generate the truth-integrity score.

2. The method according to claim 1, wherein the truth-integrity score comprises a rationale trail that cites a number of key evidence nodes and a number of relationships between the number of key evidence nodes.

3. The method according to claim 2, further comprising:
receiving the second data at an independent auditor interface; and
receiving a verification of a third-party reviewer with respect to the second data at the independent auditor interface.

4. The method according to claim 3, wherein receiving the verification is performed without altering the second data, wherein receiving the verification further comprises receiving at least one of an attestation, a dispute, and an annotation with respect to the second data by an auditor, and wherein the method further comprises immutably recording the verification in order to maintain transparency of the verification.

5. The method according to claim 2, wherein the truth-integrity score is written to a cryptographically signed audit log, and wherein applying independence-aware consensus and dynamic weighting comprises:
down-weighting at least one of a citation cascade and a redundant reference that trace to a common source; and
up-weighting at least one of an independently confirmed source of evidence and a primary source of evidence.

6. The method according to claim 5, wherein applying independence-aware consensus and dynamic weighting comprises adjusting a number of weights of the second data based on at least one of a source type of the first data, a media type of the first data, a recency alignment of the first data, a locale alignment of the first data, a presence of automated activity in the first data, and a presence of coordinated activity in the first data.

7. The method according to claim 6, wherein applying independence-aware consensus and dynamic weighting comprises adjusting a number of weights of the second data based on the media type of the first data, and wherein the method further comprises integrating a number of artificial intelligence (AI) generation and manipulation detectors, metadata and exchangeable image file format validation, and cross-platform voice, face, and handle linkages as a number of additional nodes in the evidence graph.

8. The method according to claim 2, wherein converting the first data into the second data comprises:
extracting a number of atomic propositions from the first data;
retrieving heterogeneous evidence from a number of independent sources; and
normalizing the evidence into comparable feature vectors in order to capture corroboration and contradiction relationships among the number of atomic propositions and the number of independent sources.

9. The method according to claim 8, wherein the number of independent sources comprises at least one of a number of news archives, a number of government records, a number of academic databases, at least one web content, a number of social graphs, and a number of media provenance signals.

10. The method according to claim 8, wherein the comparable feature vectors are based on at least one of recency, authorship, independence, historical reliability, geotemporal fit, and manipulation risk.

11. The method according to claim 1, further comprising performing bias calibration on the second data with a bias & distortion calibration module in order to account for distortion effects introduced by at least one of monetization and engagement-driven ranking algorithms used by third-party platforms.

12. The method according to claim 1, further comprising:
detecting an instability in the truth-integrity score;
automatically identifying a weakest node in the evidence graph; and
suggesting at least one of a new query, a new data source, and an alternative phrasing in order to improve a reliability of the truth-integrity score and allow for an iterative refinement of the second data toward a higher truth-integrity.

13. The method according to claim 1, further comprising:
detecting citation dependency and source lineage within the second data;
identifying at least one evidence chain within the second data that originates from a single primary source;
automatically de-weighting a first portion of the second data that collapses into a single origin;
identifying a second portion of the second data as being independently corroborated; and
preventing echo amplification among a third portion of the second data, the third portion comprising a plurality of sources each repeating an identical unverified claim.

14. The method according to claim 1, further comprising:
basing the truth-integrity score on a quality of the second data, an independence of the second data, and a verification of the second data;
generating a confidence score representing a certainty level with respect to an evaluation of the truth-integrity score;
prohibiting the truth-integrity score and the confidence score from collapsing into a single scalar output; and
sending an output comprising the truth-integrity score and the confidence score to a user device such that the output ranges from a low integrity level and a high confidence level to a high integrity level and a low confidence level.

15. The method according to claim 1, further comprising:
applying a time-based decay function to a number of evidence inputs associated with the second data;
automatically reducing an integrity weight for a first evidence input of the number of evidence inputs because the first evidence input is at least one of aged and outdated;
providing a temporal integrity warning to a user device if a portion of the second data of the truth-integrity score is determined to be stale data;
automatically triggering a review required state responsive to a predetermined time threshold having been exceeded in the generation of the truth-integrity score; and
storing the truth-integrity score in a storage for comparison to other truth-integrity scores.

16. The method according to claim 1, further comprising:
establishing a minimum traceability requirement for the second data before outputting the truth-integrity score as an output to a user device;
automatically suppressing the output if at least one evidence path of the second data falls below a predetermined explainability threshold;
determining whether the second data comprises a sufficient level of evidence, a determinable level of evidence, a complete level of evidence, and a conflict-free level of evidence; and
preventing the truth-integrity score from being generated if the second data does not comprises at least one of the sufficient level, the determinable level, the complete level, and the conflict-free level.

17. The method according to claim 1, further comprising:
determining a number of original evidence sources associated with the second data;
providing for full provenance tracking from the number of original evidence sources to an output comprising the truth-integrity score;
storing a number of evidence transformation steps associated with at least one of converting the first data into the second data, and applying independence-aware consensus and dynamic weighting to the second data, the number of evidence transformation steps comprising at least one of a filtering step, a weighting step, and an aggregation step; and
logging an evidence lineage associated with the second data in order to verify and review how the truth-integrity score was generated.

18. The method according to claim 1, further comprising:
separating the second data into a plurality of isolated domains each corresponding to at least one of a logical category of claim type and a subject matter type;
preventing integrity leakage across a number of domains of the plurality of domains which have been determined to be unrelated to one another;
providing at least one independent scoring model for each of the plurality of domains;
performing validation of at least one of the plurality of domains; and
performing cross-domain aggregation on the at least one of plurality of domains after validation has been performed.

19. The method according to claim 1, further comprising:
detecting drift of the truth-integrity score due to at least one of model updates, data shifts, and ingestion changes;
automatically sending an alert to a user device if the truth-integrity score has deviated beyond a defined threshold;
restoring alignment of the truth-integrity score with a prior integrity baseline responsive to at least on re-evaluation protocol being applied to the truth-integrity score; and
storing a pre-drift state and a post-drift state of the truth-integrity score.

20. The method according to claim 1, further comprising:
continually calibrating a source reliability associated with the second data based on historical accuracy;
dynamically adjusting a source weighting associated with the second data over time;
separating a source popularity associated with the second data from the source reliability;
generating a plurality of other truth-integrity scores; and
penalizing a number of sources associated with the second data based on the number of sources repeatedly degrading integrity outcomes in the truth-integrity score and the plurality of other truth-integrity scores.

21. The method according to claim 1, further comprising:
preventing the truth-integrity score from being outputted as an output to a user device responsive to a predetermined integrity threshold not being met by the truth-integrity score;
prohibiting at least one of speculation and inferential completion from being associated with the generation of the truth-integrity score;
limiting the output to evidence-supported conclusions only; and
distinguishing within the output between unknown portions, unsupported portions, and false portions.

22. The method according to claim 1, wherein the truth-integrity score comprises a quantitative output and a structural representation, wherein the structural representation is in the form of an integrity tree in order to visualize how the quantitative output was formed, wherein the integrity tree comprises a final verified conclusion functioning as a trunk of the structural representation, at least one major evidence category digitally extending from the final verified conclusion and functioning as a primary branch of the structural representation, and at least one individual source digitally extending from the final verified conclusion and functioning as a secondary branch of the structural representation.

23. The method according to claim 22, wherein the structural representation further comprises raw data digitally extending from each of the at least one major evidence category and the at least one individual source and functioning as leaves of the structural representation.

24. The method according to claim 23, further comprising:
applying a first machine-enforced policy to the second data in order to govern a formation, a depth, and a weight of both the primary branch and the secondary branch;
applying a second machine-enforced policy to the second data in order to prevent a density of each of the primary branch and the secondary branch from being artificially inflated; and
applying a third machine-enforced policy to the second data in order to automatically prune the structural representation responsive to at least one of a corresponding weakness determination and a corresponding redundancy determination.

25. The method according to claim 1, further comprising:
distinguishing within the second data between claim states corresponding to an unverified state, a supported state, a weakened state, a contradicted state, and a retired state;
automatically transitioning between the claim states based on an evidence change;
preventing the evidence change from being undetected; and
storing the claim states of the second data in a storage in order to allow for audit and comparison of the claim states.

26. A system for generating a truth-integrity score, comprising:
an input ingest and normalization layer configured to receive a target item, the target item comprising first data corresponding to at least one of a textual claim, a document excerpt, an image, a video, a profile, and a URL;
an entity extraction module configured to convert the first data into second data corresponding to an evidence graph; and
a scoring engine configured to apply independence-aware consensus and dynamic weighting to the second data in order to generate the truth-integrity score.
